(19) United States
(12) Patent Application Publication
(10) Pub. No.: US 2013/0029826 A1
(43) Pub. Date: Jan. 31, 2013

(54) Multi-Web Multi-Collect Folder and Method

(71) Applicants: John Sheridan Richards, Barrington, NH (US); Jean Claude Pautrat, Shanghai (CN)

(72) Inventors: John Sheridan Richards, Barrington, NH (US); Jean Claude Pautrat, Shanghai (CN)

(73) Assignee: GOSS INTERNATIONAL AMERICAS, INC., Durham, NH (US)

(21) Appl. No.: 13/543,117

(22) Filed: Jul. 6, 2012

Related U.S. Application Data
(60) Provisional application No. 61/505,254, filed on Jul. 7, 2011.

(51) Int. Cl. B31B 1/14

(52) U.S. Cl. 493/360; 493/362

(57) ABSTRACT

A folder for a printing press is provided. The folder includes a first cutting cylinder for cutting a first web into a plurality of first sheets, a second cutting cylinder for cutting the second web into a plurality of second sheets and for holding a second sheet, a transfer cylinder receiving at least one first sheet and at least one second sheet at a transfer location and a storage cylinder storing at least one of the plurality of second sheets cut from the web, the second cutting cylinder capable of transferring second sheets to the storage cylinder. A printing press and methods are also provided.

Priority is hereby claimed to U.S. Provisional Patent Application No. 61/505,254 filed on Jul. 7, 2011, the entire disclosure of which is hereby incorporated by reference herein.

The present invention relates to printing presses and more particularly to folders in a printing press.

### BACKGROUND

Folders in a printing press may be operated to run in a “collect” mode in which the folder accumulates a predetermined number of products before passing the accumulated products along. Folders running in collect mode are often fed by multiple webs which were previously accumulated in page groupings from multiple printing groups, for example web offset printing units. The collect cylinder is typically arranged to selectively feed, for example, sheets in a two collect delivery, a three collect delivery, and so on. A two collect refers to a delivery of two sets of sheets at a time, and a three collect involves a delivery of three sets of sheets at a time. Alternatively, the folder may operate in a straight mode, in which the folder does not accumulate any products but rather delivers a set of single sheets at a time to a downstream operation.

Digital printing presses do not require the use of printing plates and thus have a quicker and less expensive turnaround time than traditional lithographic and flexographic printing presses. Further, digital printing presses can produce different images in successive revolutions if a digital print unit is being used including for example, direct imaging pages in an offset printing press. If another type of digital printer is being used, different images may be successively printed on the web as desired. When multiple sets of different pages are produced digitally and when multiple sets of pages with different subject matter can be selectably sequenced onto one web, the associated folders cannot accumulate or “collect” a varying number of products in the traditional manner. Consequently, the capabilities of a digital printing press would be greatly reduced when using traditional collect mode folders.

U.S. Publication No. 2007/0135286, hereby incorporated by reference herein, discloses a folder having a collect cylinder mounted for rotation and a collect cylinder drive mechanism for rotating the collect cylinder.

U.S. Pat. No. 7,744,518, hereby incorporated by reference herein, discloses a folder that includes a device for cutting sheets from a web of paper, a folding cylinder provided with movable retention devices and movable blades for folding the sheets cut from the web, a cam for controlling the movement of the movable retention devices by contact with cam followers, a cam for controlling the movement of the tucking blades by contact with cam follower, and at least one covering cam. The covering cam includes two semi-cams which can each be moved radially between a retracted position and an extracted position, the covering cam being in a configuration for straight operation when the semi-cams are in a retracted position and in a configuration for collect operation when the semi-cams are in an extracted position.

### SUMMARY

The present invention produces sheets from two separate webs digitally printed and overlaid with additional capability for cutting and storing one of the webs on a separate cylinder in the folder to be forwarded later. A variable number of sheets may be stored and combined for use later in a printed product, such as a newspaper. Newspaper sections are accumulated and folded using cutting cylinders, a transfer cylinder, a collect cylinder and a jaw cylinder in accordance with the description that follows.

The present invention provides for the production of multi-page newspapers with a selectable number of pages from digitally printed sources.

The present invention provides a folder. The folder includes a first cutting cylinder for cutting a first web into a plurality of first sheets, a second cutting cylinder for cutting the second web into a plurality of second sheets and for holding a second sheet, a transfer cylinder receiving at least one first sheet and at least one second sheet at a transfer location and a storage cylinder storing at least one of the plurality of second sheets cut from the web, the second cutting cylinder capable of transferring second sheets to the storage cylinder.

The present invention also provides a printing press including at least one printing unit for printing a first web and a folder in accordance with the present invention.

The present invention provides an additional folder for a printing press including a first cutting cylinder for cutting a first web into a plurality of first sheets, a second cutting cylinder for cutting a second web into a plurality of second sheets and a transfer cylinder receiving at least one first sheet and at least one second sheet at a transfer location.

The present invention also provides a method of forming a printed product including the steps of printing a first web with at least one printing unit, cutting the first web into a first sheets, cutting a second web into second sheets and gripping at least one first sheet and at least one second sheet together at a transfer location on a transfer cylinder.

The present invention provides a further method of forming a printed product including the steps of printing a first web with at least one printing unit, cutting the first web into a first sheets, cutting a second web into second sheets and gripping at least one first sheet and at least one second sheet together at a transfer location on a transfer cylinder.

Conventional folders do not include a transfer cylinder. Including a transfer cylinder eliminates the creation of “macaroni.” Macaroni, as known in the art, are slivers of paper resulting from a new cut made adjacent to one or more already collected products, thereby severing the previously collected products. In accordance with the present invention, the cutting cylinders cut the respective webs into printed products against the transfer cylinder, the transfer cylinder then transfers each individual product to the collect cylinder after the printed products are cut and combined on the transfer cylinder. As a result, there are no previously cut pages at the point of cutting a new sheet. As a result, the collect cylinder does not serve as a counter cylinder to the cutting cylinder, the collect cylinder simply collects printed products already cut from the web.

### BRIEF DESCRIPTION OF THE DRAWINGS

A preferred embodiment of the present invention is described below by reference to the following drawings, in which:

FIG. 1 shows a printing press having a folder according to the present invention;

FIGS. 2 to 4 show a folder arrangement operating in one of a plurality of preferred modes according to the present invention.

### DESCRIPTION OF THE DRAWINGS

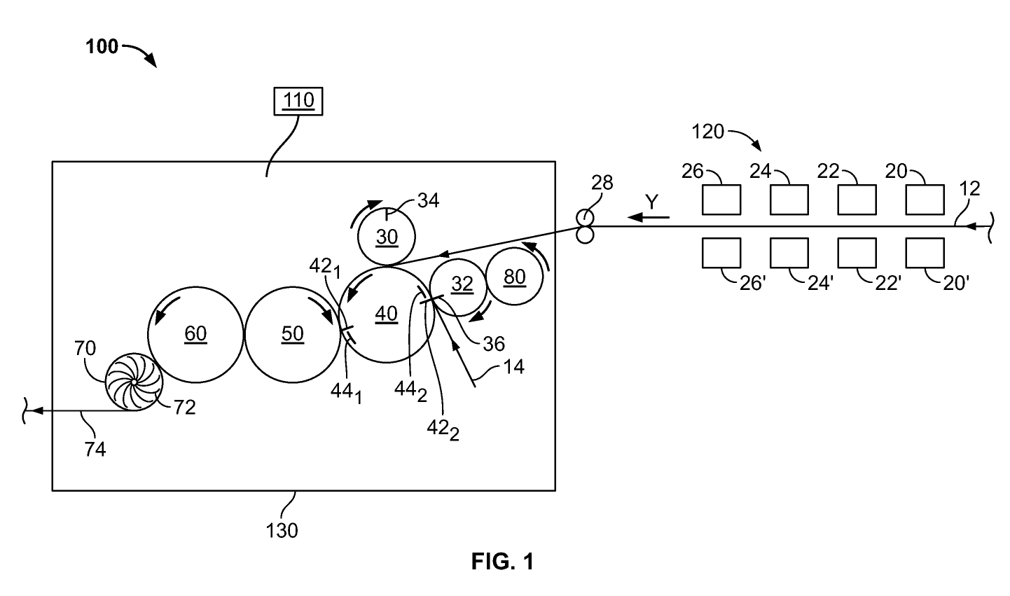

FIG. 1 shows a printing press 100 including a folder 30 in accordance with the present invention. Printing press 100 includes printing section 120 and a folder 130. Printing section 120 includes a plurality of printing units 20, 20′, 22, 22′ 24, 24′ 26, 26′. Printing units may be, for example, digital print units, including ink jet printers or laser printers. Preferably, press 100 includes digital print engines 20, 20′, 22, 22′, 24, 24′, 26, 26′ located on either side of web 12 for printing on both sides of web 12 as web 12 travels in a direction Y. The number of digital print engines used may vary as desired.

Web 12 may be aided by guide rollers or nip rollers 28 as web enters folder 130. A previously printed web 14 may be combined with web 12 in folder 130. Web 14 may be printed by other printing units, for example, other digital print units. Webs 12, 14 may be combined to produce a section, for example, a subject matter section of a newspaper such as sports or business.

Folder 130 includes, for example, a one-around cutting cylinder 30. As known in the art, a one-around cylinder has a circumference that corresponds to a length of a single sheet. A two-around cylinder has a circumference that corresponds to a length of two sheets. Folder 130 further includes, for example, a second one-around cutting cylinder 32, a one-around storage cylinder 80, a two-around transfer cylinder 40, a two around collect cylinder 50 and a two around jaw cylinder 60. Folder 130 may also include a fan wheel 70 having fan blades 72 and a delivery or conveyor 74. A controller 110 and/or user interface may be provided in order to control components of press 100 including folder 130, printing section 120.

Each web 12, 14 is cut into sheets by a cutting blade 34, 36 on a respective cutting cylinder 30, 32. Blades 34, 36 cut against an anvil or cutting rubber 44₁, 44₂ for this purpose. Transfer cylinder 40 also includes pins 42₁, 42₂ at transfer locations which hold a lead edge of a new sheet to be cut from webs 12, 14. Pins 42₁, 42₂ may be any form of signature gripping device for example, pins, mechanical grippers or vacuum grippers. Cutting blades 34, 38 extend and cut webs 12, 14, respectively, into sheets A, B against a surface of transfer cylinder 40.

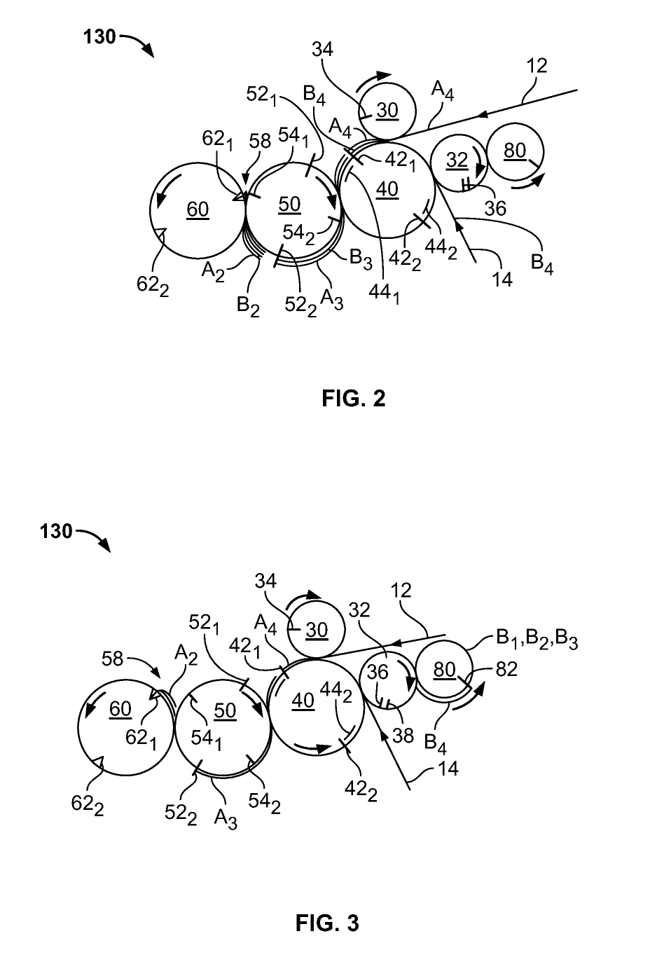

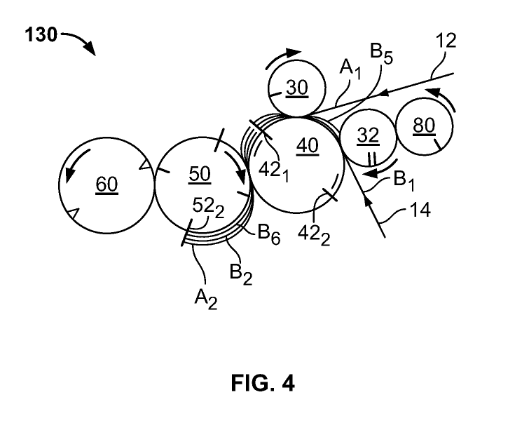

Sheets A, B are combined together at a pin 42₁, 42₂ on transfer cylinder 40. As illustrated in FIGS. 2 and 4, sheet A and sheet B are collected together at pin 42₁ then transferred together to collect cylinder 50. Collect cylinder 50 also includes pins 52₁, 52₂ at the two collect locations. Pins 52₁, 52₂ may also be any type of sheet gripping device, for example, pins, mechanical grippers or vacuum grippers. Collect cylinder 50 also includes tucking blades 54₁, 54₂ for tucking signatures into jaws 62₁, 62₂ of jaw cylinder 60.

In accordance with a feature of the present invention, cutting cylinders 30, 32 and transfer cylinder 40 may work in a plurality of modes. FIG. 3 shows a preferred embodiment and operating mode in which, at first, sheets from only one web are collected and folded. In the example illustrated, collect cylinder 50 is running in a straight or one-collect mode. In the present embodiment, sheets B, illustrated as B₁, B₂, B₃ B₄, are cut from web 14 and stored around a circumference of storage cylinder 80 until desired. Cutting cylinder 32 includes a gripper 38, for example, a pin or mechanical gripper, gripping a lead edge of incoming web 14. Web 14 wraps around cutting cylinder 32 as cylinder 32 rotates. The lead edge of web 14 is transferred to a gripper 82 on storage cylinder 80. Blade 36 cuts a trail edge of the next sheet B to be cut, sheet B4, against cutting rubber 42₂ and gripper 38 grips the new lead edge of web 14. Newly cut sheet B4 is then stored on storage cylinder 80 until desired as illustrated by B₁, B₂, B₃.

Concurrently, cutting cylinder 30 cuts sheets A, illustrated as A₁, A₂, A₃, A₄, from web 12. As shown in FIG. 3, the next cut by cutting cylinder 30 will cut sheet A4 from web 12 a lead edge of which is gripped by gripper 42₁ on transfer cylinder 40. The next cut by cutting cylinder 32 will cut sheet B4 from web 14 a lead edge of which is gripped by gripper 82 on storage cylinder 80. In this first mode, only sheets A₁, A₂, A₃, A₄ cut from web 12 are passing to pins 42₁, 42₂ for transfer to collect cylinder 50. A section 58 including sheet A₂ has been formed at jaw 62₁ of jaw cylinder 60. Section 58 was tucked and folded off of pin 52₁ on collect cylinder 50 by tucking blade 54₁. In this embodiment, sheet A₃ is collected at pin 52₂ and will be tucked into jaw 62₂ by tucking blade 54₂ for formation of subsequent section. Sheet A₄ will form a third folded section, etc.

By providing a storage cylinder 80, sheets B, for example, B₁, B₂, B₃, B₄, can be stored for multiple revolutions if sheets B are not immediately needed at pins 42₁, 42₂. When sheet B is desired sheet B can be reinserted via cutting cylinder 32 without negatively interacting with web 14 which continues to pass into folder 130. Cutting cylinder 32 may also be designed to store and release sheets B. Storage cylinder 80 is preferably tangent to cutting cylinder 32. If sheet B is needed after only one rotation of cylinder 32, sheet B is reinserted onto the web as soon as sheet B has completed one revolution on cutting cylinder 32.

In a second preferred operating mode, shown in FIG. 2, both cutting cylinders 30, 32 cut sheets A, B from webs 12, 14 respectively. Sheets 12, 14 are transferred to a same pin 42₁, 42₂ and overlaid on top of each other at each pin 42₁, 42₂. First, pin 42₁ grips a lead edge of web 14 and transfer cylinder 40 rotates counter-clockwise as shown, moving web 14 via pin 42₁. Pin 42₁ receives a lead edge of web 12 over top of web 14. Thus, pin 42₁ is thereby gripping both webs 12, 14 by the leading edges of next-to-be-cut sheets A₄, B₄. Cutting cylinder 32 then cuts a trailing edge of sheet B₄ and a second pin 42₂ on transfer cylinder 40 grips the new leading edge of web 14. As transfer cylinder 40 continues to rotate, cutting cylinder 30 cuts sheet A₄ from web 12. When sheet A₄ is cut from web 12, both sheets A₄, B₄ may be gripped by transfer pin 42₁, however, the lead edges of A₄, B₄ may also have been already transferred together to a collect pin 52₁ on collect cylinder 50. With reference to FIG. 2, lead edges of sheets A₃, B₃ were gripped by collect pin 52₂ when cutting cylinder 30 cut a trailing edge of sheet A₃.

As illustrated in FIG. 2, a section 58 has just been formed at jaw 62₁ which includes sheet A₂ and sheet B₂. Section 58 was folded off pin 52₁ by tucking blade 54₁. Section 58 includes two sheets each having four pages for a total section page count of 8 pages. A second set of collected sheets including sheet A3 and sheet B3 is gripped by pin 52₂ on collect cylinder 50 and will be formed into a subsequent section also having 8 pages. A lead edge of web 12 has been collected over top of a lead edge of web 14 at pin 42₁ on transfer cylinder 40. The next cuts by cylinders 30, 32 will form sheets A₄, B₄ from webs 12, 14 respectively. In this mode, new sheets B cut from web 14 are being used in the folder directly and are not being stored on cylinder 80 or cylinder 32. However, cylinder 80 may include sheets B previously cut from web 14 and stored thereon.

FIG. 4 shows folder 130 operating in a third preferred mode of the present invention. Storage cylinder 80 transfers a previously stored sheet, illustrated here as sheet B₅, to cutting cylinder 32 which is combined with an incoming sheet B₁ to be cut from web 14 and also with an incoming sheet A₁ to be cut from web 12 resulting in an overlaid group of three sheets at pin 42ₖ. In the same manner, a set of three sheets A₂, B₂, B₆ previously transferred to and overlaid at pin 42₂ is shown collected at pin 52₂ on collect cylinder 50. When sheets A₂, B₂, B₆ are folded off into jaw 62₂ by tucking blade 54₂, a 12 page section (3 sheets each having 4 pages) will be formed.

Using the three previously described modes in combination with one another allows any number of sheets to be combined at pins 52₁, 52₂ on collect cylinder 450. See Table 1. When three sheets are collected at a transfer pin 42₁, 42₂, a choice between operating in Mode 1 in combination with Mode 2 or operating in Mode 3 may depend upon the availability of sheets B stored on storage cylinder 80. For example, if storage cylinder 80 does not include a stored sheet B, (sheet B₅ as illustrated in FIG. 4) Mode 3 cannot be operated because sheet B₅ is not available.

TABLE 1
Operating Modes

| Number of | |
|---|---|
| Sheets | |
| collected | |
| at each | |
| Collect Pin | Modes used to Obtain Desired Signature Count |
| 1 | Mode 1 - Sheets A delivered from web 12 |
| 2 | Mode 2 - Sheets A, B delivered from webs 12, 14, |
| | respectively |
| 3 | Mode 1 then Mode 2; or |
| | Mode 3 - Sheet B is stored on cylinder 80 and a second |
| | sheet B is cut from web 14, two sheets B (B1, B5) are |
| | then combined with a sheet A |
| 4 | Mode 2 then Mode 2 |
| 5 | Mode 2 then {[(Mode 1 then Mode 2) or (Mode 2 then |
| | Mode 1)] or Mode 3} or {[(Mode 1 then Mode 2) or |
| | (Mode 2 then Mode 1)] or Mode 3} then Mode 2 |

During the collection of four sheets on a collect pin 52₁, 52₂, collect cylinder 50 may be running in a two-collect mode in order to collect a second set of sheets. As illustrated in FIG. 2, two sheets A₄, B₄ are collected at pin 42ₖ. Sheets A₄, B₄ will be transferred to pin 52₁ on collect cylinder 50. A second pair of sheets A_{N}, B_{N} is then overlaid on top of sheets A₄, B₄ at pin 52₁ so a total of four sheets A₄, B₄, A_{N}, B_{N} is retained at pin 52₁.

Similarly, during the collection of five sheets on a collect pin 52₁, 52₂ the collect cylinder is operating in either a two-collect mode or a three-collect mode. If transfer cylinder 50 is operating in a two-collect mode, cylinder 50 makes two full rotations before transferring collected sheets to jaw cylinder 60. Thus, when five sheets are desired on a collect pin 52₁, 52₂, and collect cylinder 50 is running in two-collect mode, a combination of operating Mode 2 and operating Mode 3 are used to collect the five sheets. Operating Mode 2 provides two sheets A₄, B₄, from a pin 42₁ on transfer cylinder 40 (FIG. 2) and operating Mode 3 provides three sheets A₁, B₁, B₅ from a pin 42₁ on transfer cylinder 40 (FIG. 4). Collect cylinder pin 52₁ will receive each set of sheets, the second set being overlaid on top of the first set, thereby collecting five sheets at pin 52₁. Thus, in two rotations collect cylinder 50 accumulates five sheets A₄, B₄, A₁, B₁, B₅ at a pin 52₁. The order of operating mode 2 and operating mode 3 is variable, e.g. mode 2 then mode 3 or mode 3 then mode 2.

In contradistinction, collect cylinder 50 may be run in three-collect mode when five sheets are desired on each transfer pin 52₁, 52₂. During a three-collect run, collect cylinder 50 will make three full rotations before transferring sheets collected thereon to collect cylinder 50. During each rotation, sheets are provided to pin 52₁ in accordance with operating Mode 2 twice and in accordance with operating Mode 1 once. Each operating Mode 2 provides two sheets to pin 52₁ (FIG. 2) and operating Mode 1 provides one sheet to pin 52₁ (FIG. 3) for a total of five sheets. Operating Modes 2 and operating Mode 1 may be run in any order desired, for example, mode 2, mode 2, mode 1 or mode 2, mode 1, mode 2, or mode 1, mode 2, mode 2.

Further flexibility of folder 130 is provided by collect cylinder 50 which may run in, for example, straight or one-collect mode, two-collect mode or three-collect mode, etc. to accumulate the desired number of sheets. Once the desired number of sheets is obtained at a collect pin 52₁, 52₂, sheets are folded into a jaw 62₁, 62₂ of jaw cylinder 60 via a tucking blade 54 located on collect cylinder 50.

After folding by jaw cylinder 60, sections are transferred to a fan 70, which includes fan blades 72. A folded product or section is received between each fan blade 72. Fan 70 may subsequently deposit newspaper sections onto a conveyor or delivery stream 74 for further processing.

Printing press 100 may be used to print and form printed products such as newspapers, for example, tabloid or broadsheet newspapers. The printed products may be single section products, for example, a tabloid newspaper, or multi-section products, for example, a multi-section broadsheet newspaper.

In other preferred embodiments, various locations for storage cylinder 80 gathering the stored sheets are possible and stored sheets may be gathered in a location other than on a cylinder. Sheets may also be stored on another cylinder, for example, cutting cylinder 32 as opposed to storage cylinder 80.

Mechanisms located on the cylinders 30, 32, 40, 50, 60 and 80 including pins, cutting blades, grippers, jaws and other mechanisms may be selectably, actuatable and/or programmable. The cylinder mechanisms may also be silenced or retractable when desired.

In a further preferred embodiment, a third web may be cut by a third cutting cylinder, with at least one cylinder being able to store and forward sheets.

In the preceding specification, the invention has been described with reference to specific exemplary embodiments and examples thereof. It will, however, be evident that various modifications and changes may be made thereto without departing from the broader spirit and scope of invention as set forth in the claims that follow. The specification and drawings are accordingly to be regarded in an illustrative manner rather than a restrictive sense.

What is claimed is:

1. A folder for a printing press comprising:
a first cutting cylinder for cutting a first web into a plurality of first sheets;
a second cutting cylinder for cutting the second web into a plurality of second sheets and for holding a second sheet;
a transfer cylinder receiving at least one first sheet and at least one second sheet at a transfer location; and
a storage cylinder storing at least one of the plurality of second sheets cut from the web, the second cutting cylinder capable of transferring second sheets to the storage cylinder.

2. The folder as recited in claim 1 further comprising:
a collect cylinder accumulating the first and second sheets received from the transfer cylinder at a collect location; and
a jaw cylinder receiving and folding the first and second sheets from the collect location to form a printed product.

3. The folder as recited in claim 1 wherein the storage cylinder releases a stored second sheet, the stored second sheet being transferred together with the at least one second sheet to the transfer location.

4. The folder as recited in claim 1 wherein the transfer cylinder receives more than one first or second sheet at the transfer location.

5. The folder as recited in claim 1 further comprising at least one of pins, grippers or a vacuum to hold leading edges of the first and second sheets.

6. The folder as recited in claim 2 wherein the collect cylinder runs in a straight mode.

7. The folder as recited in claim 2 wherein the collect cylinder makes at least one full rotation before transferring sheets to the jaw cylinder.

8. A printing press comprising:
at least one printing unit for printing a first web; and
the folder as recited in claim 1.

9. The printing press as recited in claim 8 wherein the at least one printing unit is a digital printing unit.

10. A folder for a printing press comprising:
a first cutting cylinder for cutting a first web into a plurality of first sheets;
a second cutting cylinder for cutting a second web into a plurality of second sheets; and
a transfer cylinder receiving at least one first sheet and at least one second sheet at a transfer location.

11. The folder as recited in claim 10 further comprising:
a storage cylinder receiving at least one second sheet from the second cutting cylinder and storing the at least one second sheet.

12. The folder as recited in claim 10 further comprising:
a collect cylinder accumulating the at least one first sheet and at least one second sheet received from the transfer cylinder at a collect location; and
a jaw cylinder receiving and folding the first and second sheets from the collect location to form a printed product.

13. The folder as recited in claim 12 wherein the printed product is a newspaper.

14. A method of forming a printed product comprising the steps of:
printing a first web with at least one printing unit;
cutting the first web into a first sheets;
cutting a second web into second sheets; and
gripping at least one first sheet and at least one second sheet together at a transfer location on a transfer cylinder.

15. The method as recited in claim 14 further comprising the step of:
holding a second sheet on the second cutting cylinder for at least one rotation.

16. The method as recited in claim 11 further comprising the steps of:
collecting the at least one first and second sheets on a collect cylinder at a collect location; and
folding the at least one first and second sheets received from the collect cylinder together to form a printed product.

17. The method as recited in claim 16 further comprising the step of:
collecting at least one further first or second sheet at the collect location together with the at least one first sheet and at least one second sheet.

18. The method as recited in claim 14 further comprising the step of:
gripping at least one further first or second sheet at the transfer location together with the at least one first sheet and at least one second sheet.

19. The method as recited in claim 14 further comprising the step of:
storing further first or second sheets cut from the first or second webs.

20. The method as recited in claim 19 wherein a cutting cylinder stores the further first or second sheets.

21. The method as recited in claim 19 wherein a storage cylinder stores the further first or second sheets.
